(19) United States
(12) Patent Application Publication
(10) Pub. No.: US 2009/0112137 A1
(43) Pub. Date: Apr. 30, 2009

(54) Exercise Device

(76) Inventor: George Lamore, San Jose, CA (US)

Correspondence Address: QUICKPATENTS, INC., 32861 CALLE PERFECTO, SUITE A, SAN JUAN CAPISTRANO, CA, 92675, US

(21) Appl. No.: 11/932,194

(22) Filed: Oct. 31, 2007

(51) Int. Cl. A61H 15/00; A63B 21/00

(52) U.S. Cl. 601/112; 482/132

(57) ABSTRACT

An exercise device for a person, comprising at least two substantially rigid rails, each rail having an outer surface, and inner surface, and at least one peripheral edge connecting the outer surface to the inner surface. The at least one peripheral edge includes at least one axle slot formed therein. At least one substantially cylindrical axle has two ends and is adapted for rotatably and removably receiving at least one substantially cylindrical roller thereon. Each end of each axle is adapted to be captured within one of the axle slots of one of the rails. Each roller has a peripheral surface and a maximum diameter. Each axle is spaced a distance from an adjacent axle of at least the maximum diameter of the rollers, whereby each roller may rotate freely on the at least one axle. The exercise device is able to support a person lying on his back on the rollers on a flat surface.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to exercise devices, and more particularly to a back and leg exercising device.

### DISCUSSION OF RELATED ART

Numerous innovations for massaging apparatuses have been provided in the prior art that will be described. Even though these innovations may be suitable for the specific individual purposes to which they address, they differ from the present invention.

A first example, U.S. Patent Office Document No. 1,572,794, Issued on Feb. 09 1926, to Hamilton teaches a massage device comprising a plurality of grooved rollers of different sizes and alternately arranged, the rollers being shaped to straddle the spine. A mechanism for retaining the rollers in spaced relation to one another, a table on which the rollers travel, and a mechanism attached to the table for guiding the movement of the rollers on the table.

A second example, U.S. Patent Office Document No. 1,593,014, Issued on Jul. 20, 1926, to Bushmiller teaches a device that includes a supporting frame, a roller containing frame therein, a mechanism for adjusting the roller frame in the supporting frame, a mechanism for adjusting a portion of the rollers to different levels in the roller frame, and hand and feet elements for use by the user in moving his body upon the rollers, the rollers being of composition matter of flexible character.

A third example, U.S. Patent Office Document No. 1,748,425, Issued on Feb. 25 1930, to Odell teaches an exercise machine, comprising a frame, a plurality of spaced sectional rollers journaled in the sides of the frame and extending in parallel closely adjacent relation transversely of the length of the frame, a table portion formed at the head of the frame of spaced slats, the surface of the slats being below the upper surface of the rollers, and posts at the sides of the table portion adapted to be grasped by a person lying upon the rollers.

A fourth example, U.S. Patent Office Document No. 1,836,981, Issued on Dec. 15 1931, to Matheson teaches an apparatus comprising a frame, a plurality of rollers arranged transversely in one portion of the frame and spaced from one end thereof, the rollers disposed in a convex curve longitudinally of the frame, the portion of the frame intermediate the rollers and the end being lower in height than the portion in which the rollers are mounted, foot rests at the end, a pulley rotatably mounted in the frame, a belt frictionally engaging the pulley to resist rotation thereof, and a lever manually operable to angularly displace the pulley against the action of the belt.

A fifth example, U.S. Patent Office Document No. 2,052,656, Issued on Jan. 19, 1936, to Prien teaches a massage apparatus comprising a frame, a plurality of massage rollers horizontally arranged in the frame, the rollers being successively different in surface configuration so as to conform with the human torso and leg areas of the body and to afford a supporting medium therefore, and a mechanism for simultaneously rotating the rollers.

A sixth example, U.S. Patent Office Document No. 2,652,049, Issued on Sep. 15 1953, to Zeigler teaches a reducing mat comprising a multiplicity of relatively cylindrical elongated members connected in alternate pairs to form a continuous mat with the connections comprising elastic bands individually connecting each pair of rolling and spreading action.

A seventh example, U.S. Patent Office Document No. 3,645,256, Issued on Feb. 29, 1972, to Morrison teaches a massage-exerciser device consisting of a number of resilient discs of frustoconical shape assembled in stacked coaxial relation to form a roller having peripheral ribs and grooves, the discs being reversible whereby to vary the pattern of the ribs and grooves, hard and soft spacers adapted to be inserted selectively between the discs whereby to increase or decrease the effective hardness of the roller, and a clamp for applying a variable axial compressive load to the roller, also to vary the effective hardness thereof, and a frame for carrying a plurality of the rollers rotatably to parallel, spaced-apart relation.

An eighth example, U.S. Patent Office Document No. 3,672,358, Issued on 06-27-1972, to Majewski teaches a massage device consisting of a plurality of rollers having projections, the rollers being mounted for rotation on a carrier, rotation occurring when the rollers are placed in contact with a portion of the body to be massaged and the carrier is moved in a direction normal to the axis of rotation of the rollers, the projections preferably being of resilient material although firm enough to press into the fleshy and muscular portions of the body to produce massaging action when reciprocated over a portion of the body causing the rollers to rotate.

A ninth example, U.S. Patent Office Document No. 3,759,250, Issued on Sep. 18, 1973, to Salata teaches a device for massaging various parts of the human body, especially the arms and legs, to reduce and firm the parts, including a frame in which a pair of rollers are rotatively mounted in spaced apart, substantially in parallel relation to one another.

The frame includes extensibly mounted end portions, each carrying a roller, for varying the spacing between the rollers to enable the rollers to straddle portions of the body of different cross sectional sizes, such as the thighs, calves, upper arms and forearms. Springs connect the rollers to the frame and yieldably urge the rollers toward one another in their different adjusted positions, for applying a yieldable compressive force to the body portion being massaged.

A tenth example, U.S. Patent Office Document No. 4,688,556, Issued on Aug. 25, 1987, to Keller, Jr. teaches one or more yielding oblate spheroids rotatably held in a support frame that can roll on a support surface while the user of the device in a prone position has his or her spine resting on the rolling oblate spheroid or spheroids which gently and effectively massage the spine. The device is propelled by the legs of the user and therefore provides exercise. The tapered ends of the massage elements are releasably socketed in cup elements held on rotational bearings of the support frame.

An eleventh example, U.S. Patent Office Document No. 5,352,188, Issued on Oct. 04, 1994, to Vitko teaches a small lightweight yet strong frame housing multiple flexible axles which in turn support foam rubber roller balls which roll about an axis creating massage, intersegmental traction, trigger point therapy, and active exercise to the back of the user. These axles are made more efficient by the placement of bushings where they are contained by a frame. Foam rubber balls contain sleeves which promote free rotation. Neck roller balls are also used to facilitate optional concomitant neck and back treatment. A head rest is provided for comfort and multiple tension adjustments are provided for varying resistance to glide.

A twelfth example, U.S. Patent Office Document No. 5,588,953, Issued on Dec. 31, 1996, to Chang teaches a roller assembly for a massaging device that is composed of a shaft, a plurality of roller sleeves, and a locating plug. The shaft is provided in the hollow end thereof with a plurality of retaining ribs and is further provided at another end thereof with two lugs and a ratchet located between two lugs for holding a resilient cord. The roller sleeves are fitted rotatably over the shaft and are provided respectively on the outer wall surface thereof with a plurality of massaging protuberances. The locating plug is provided in the outer wall surface of one end thereof with a plurality of retaining slots engageable securely with the retaining ribs of the shaft. The locating plug is further provided at another end thereof with two lugs and a ratchet located between the two lugs for holding securely a resilient cord. The locating plug is secured at one end thereof to the hollow end of the shaft for locating the roller sleeves which are fitted over the shaft.

A thirteenth example, U.S. Patent Office Document No. 5,634,887, Issued on Jun. 03, 1997, to Fortier teaches massage equipment that includes a rigid frame, and at least one massage roll carried by the frame and which is freely rotatable about an axis which is fixed relative to the frame. Apparatus is provided for assisting a user, when supported against that roll, to move across that roll while applying pressure to that roll to cause roll rotation and to provide massaging action.

A fourteenth example, U.S. Patent Office Document No. 6,390,997, Issued on May. 21, 2002, to Vitko teaches a small lightweight yet strong frame housing multiple flexible axles which in turn support foam rubber roller balls which roll about an axis creating massage, intersegmental traction, trigger point therapy, and active exercise to the back of the user. These axles are made more efficient by the placement of bushings where they are contained by frame. Foam rubber balls contain sleeves which promote free rotation. A sliding head rest is provided for comfort and is also used to facilitate optional concomitant neck and back treatment and multiple tension adjustments are provided for varying resistance to glide.

A fifteenth example, U.S. Patent Office Document No. 6,419,650, Issued on Jun. 16, 2002, to Ryan et al. teaches a device for providing back massage with simultaneous acupressure stimulation along either side of the spine. The device comprises a frame in which are disposed a plurality of rollers which are freely rotatable and capable of being interchangeably positioned within the frame. One roller is of a large diameter than the remaining rollers and is provided with a central circumferential groove which is bounded on each side by a surface having a plurality of nubs. In use, the nubs contact the user's body on either side of the spine at the desired location to provide acupressure stimulation. By providing the acupressure stimulation roller in a diameter which is larger than the other rollers, the device also provides intervertebral or intersegmental extension during use.

A sixteenth example, U.S. Patent Office Document No. 200400097853, Published on May 20, 2004, to Aidiniantz teaches a device whereby one or more nodules made from firm matter are configured or moved in such a way that when the nodules are brought into contact with a human body, they correspond to, and are able to exert pressure on, the facet joints of the spine, using the weight of the body and/or some conventional power source.

Back pain and injury, and ongoing back fitness, is something that almost every individual must deal with at some point in life. For many, back pain is chronic. For others, back pain is temporary, the result of a specific injury for example. There already exists many options for treatment of these issues including surgery, physical therapy, massage therapy, standard exercises to promote back fitness, and the prior art devices heretofore described. The treatment, relief and prevention of back pain can be prohibitively costly, painful, require another individual to administer treatment or operate an associated device, and time consuming due to required travel to locations to receive treatment.

It is clear there is a need for a back therapy device that can be used by an individual at will, without requiring the presence of another individual to administer treatment or operate a back therapy device, that is customizable to an individual's needs, and that allows an individual to treat, massage, and alleviate back pain and injury and promote back health at either the direction of medical professional or as a casual consumer interested in the general benefits of massage therapy and exercise without reduced costs. Use of such a needed device would allow therapy, massage or treatment to occur when and where it was convenient to the user in the comfort of their home, office, or other location without another individual's help.

Some back injuries are so painful and limiting that current home treatments, exercises, and devices are unusable until the individual has been given numerous manual treatments and recovered health and fitness sufficient to begin a home therapy regime and engage in such activity on their own without assistance.

It is also clear for the medical professional that there is a need for a device that provides a variety of configurations and customizable options for different levels treatment for various levels of back injuries and exercises to progress therapy for injuries to full recovery. Such could be administered in the form of a home therapy regime for the patient or in the office as part of therapy with such a needed apparatus. Such therapy, in most cases, could begin earlier than was previously possible with the prior art devices and techniques, and thus the needed device would help facilitate quicker patient recovery and health.

Such a needed device would be easy to manufacture, use, maintain and replace component parts as they become worn and provide therapy and massage that is not currently possible to the vast majority of the population at a reasonable expense. The present invention accomplishes these objectives.

### SUMMARY OF THE INVENTION

An object of the present invention is to provide an exercise device that avoids the disadvantages of the prior art.

Another object of the present invention is to provide an exercise device that is simple and inexpensive to manufacture.

Still another object of the present invention is to provide an exercise device that is simple to use.

Briefly stated, still yet another object of the present invention is to provide an exercise device for a person, comprising at least two substantially rigid rails, each rail having an outer surface, and inner surface, and at least one peripheral edge connecting the outer surface to the inner surface. The at least one peripheral edge includes at least one axle slot formed therein. At least one substantially cylindrical axle has two ends and is adapted for rotatably and removably receiving at least one substantially cylindrical roller thereon. Each end of each axle is adapted to be captured within one of the axle slots of one of the rails. Each roller has a peripheral surface and a maximum diameter. Each axle is spaced a distance from an adjacent axle of at least the maximum diameter of the rollers, whereby each roller may rotate freely on the at least one axle. The exercise device is able to support a person lying on his back on the rollers on a flat surface.

The current invention is a customizable roller device upon which a user lays and, through extension and contraction of the user's legs, he massages his back therewith. The various custom sizes and knobs of the roller sections and the way they are placed on each axel and the rails provide custom massage therapy to the user as he rolls back and forth. Such therapy provides relief of pain, soreness, promotes relaxation, and over time and with repeated use provides an exercise to increase back health and fitness.

The invention described herein has many advantages over and the prior art methods and devices for back therapy. Primarily, it is customizable for many different needs, injury pain levels, and fitness levels with the interchangeable rollers. For example, a person with a severe back strain and muscle tenderness can use rollers that have small, soft, spongy knobs on all three axles mounted in the rail system, thus providing a gentle massage distributed over a relatively large surface area and providing maximum support to the user's back so he does not have to overly strain himself. Rolling back and forth gently over the soft knobs of the rollers in this configuration massages muscles that are in spasm into releasing and relaxing without further injuring the user. As the user recovers and heals he swaps soft knob rollers for rollers with firmer knobs to increase the intensity of the massage and further treat knotted back muscles.

The invention described herein can be used by an individual anytime and anywhere, not just in the presence of a doctor or physical therapist. The present device is easily maintained, inexpensive and easy to manufacture, and provides for easy replacement of component parts as they become worn. Further, the present device provides a greater variety of massage, therapy, and exercise options.

The device can be packaged and sold in variety of configurations for different needs. For example, a basic package for home use has a standard set of medium firmness rollers and knobs, enough to fill three axles mounted on the axle rails. Such a system may further include a few additional medium firmness rollers with different custom-shaped knobs that the user can interchange for a basic variety of massage therapy exercises.

Another package, for a professional Physical Therapist for example, includes two complete devices, plus enough rollers with all the knob shapes and firmness characteristics (soft, medium, hard) to completely fill both rail axle systems with a complete set of rollers at the different firmness levels so as to meet the therapy needs of their patients. Such a package includes enough rollers to allow their patients to progress them from the initial level of injury back to complete health.

All the advantages and features of the invention herein shall become apparent from the following more detailed description, taken in conjunction with accompanying drawings, which illustrate by way of example, the principles of the invention.

### DESCRIPTION OF THE DRAWINGS

FIG. 1 is a partly exploded perspective view of an embodiment of the present invention;

FIG. 2 is a top view of the present invention;

FIG. 3 is a plan view of an axle with rollers thereon;

FIG. 4 is a plan view of the axle per se;

FIG. 5 is a right side view of the present invention;

FIG. 6A is a partial right side view of a rail, showing a locking clip in an open position;

FIG. 6B is a partial right side view of the rail, showing the locking clip in a closed position; and

FIG. 7 is a perspective view showing the present invention in use and illustrating an alternate embodiment of the rail.

### DETAILED DESCRIPTION OF THE PREFERRED EMBODIMENT

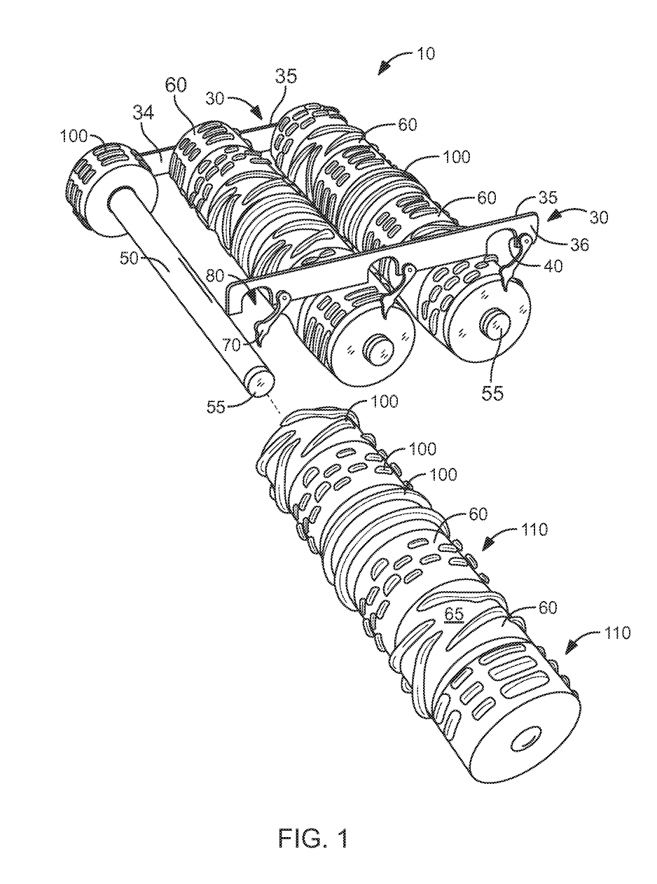

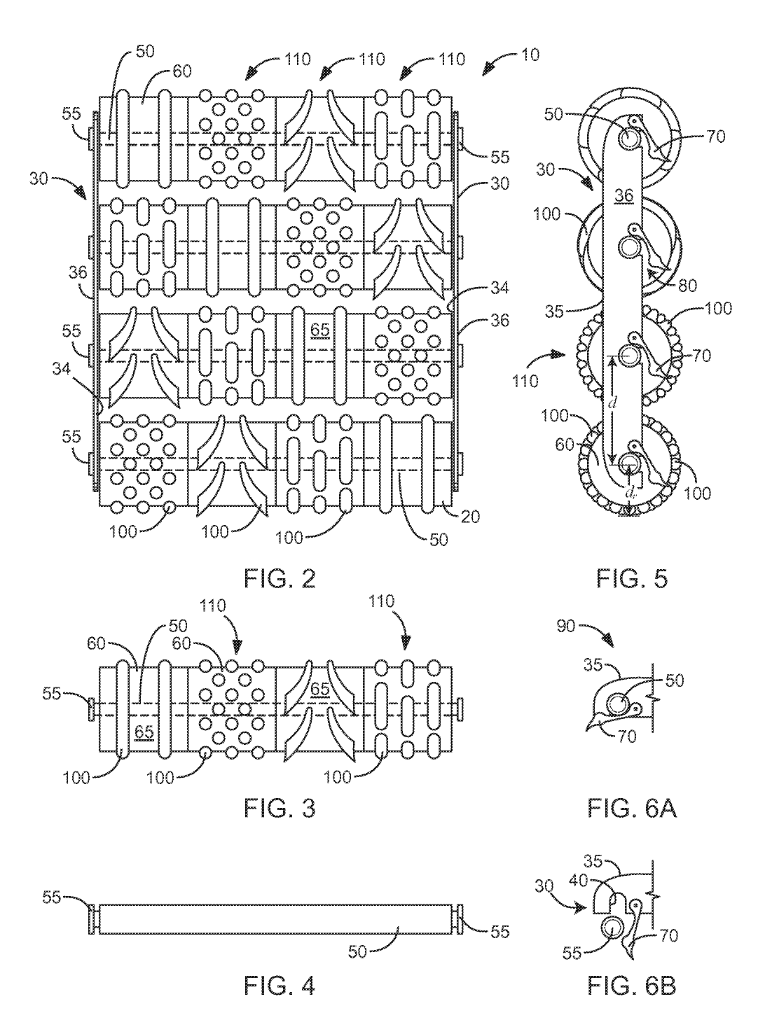

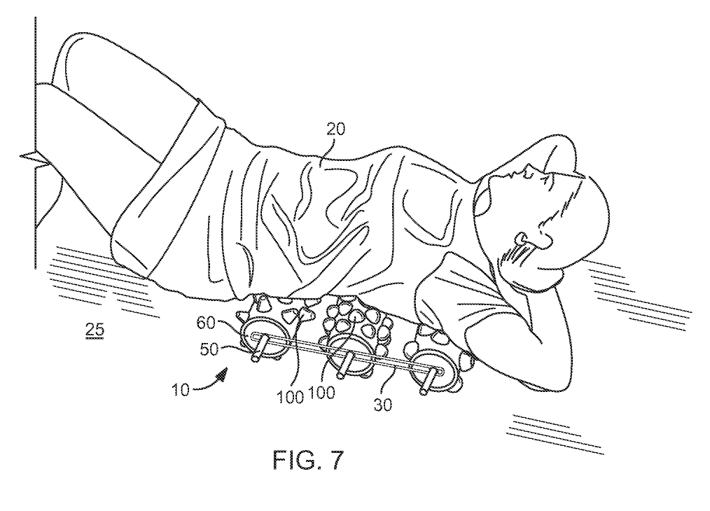

Referring now to the figures, in which like numerals indicate like parts, and particularly to FIGS. 1 through 7, the present invention will be discussed with reference thereto. An exercise device 10 for a person 20 is provided. The exercise device 10 comprises at least two substantially rigid rails 30, made of rigid plastic or metal, such as aluminum, for example. Each rail 30 has an outer surface 36, and inner surface 34, and at least one peripheral edge 35 connecting the outer surface 36 to the inner surface 34. The at least one peripheral edge 35 includes at least one axle slot 40 formed therein.

At least one substantially cylindrical axle 50 has two ends 55 and is adapted for rotatably and removably receiving at least one substantially cylindrical roller 60 thereon. Each end 55 of each axle 50 is adapted to be captured within one of the axle slots 40 of one of the rails 30. Each roller 60 has a peripheral surface 65 and a maximum diameter dᵣ. Each axle 50 is spaced a distance d from an adjacent axle 50 of at least twice the maximum diameter dᵣ of the rollers 60, whereby each roller 60 may rotate freely on the at least one axle 50. The exercise device 10 is able to support the person 20 lying on his back on the rollers 60 on a flat surface 25.

Each rail 30 may further include a locking clip 70 pivotally fixed thereto proximate each axle slot 40. Each locking clip 70 is adapted for selective detented placement in an open position 80 or closed position 90. The peripheral surface 65 of at least one roller 60 includes a plurality of raised portions 100 that form a tread pattern 110 thereon.

The plurality of raised portions 100 may each be less than 0.25 inches in height. The plurality of raised portions 100 may each be substantially between 0.25 inches and 0.75 inches in height. The plurality of raised portions 100 may each be substantially greater than 0.75 inches in height. The plurality of raised portions 100 may each be made from a resilient foam material, rubber, or other resilient material. The plurality of raised portions 100 may each be made from a rigid plastic material. The rollers 60 may be interchanges on each axle 50 as desired to accomplish different types of therapy. For example,

For exercising and massaging a back of the person 20 the following steps are taken:
1. Provide the exercise device 10.
2. Instruct the person 20 to position the exercise device 10 between his back and the flat surface 25.
3. Instruct the person 20 to use his legs to move his back, back and forth to allow the rollers 50 to roll between his back and the flat surface 25, thereby exercising and massaging the back of the person 20 therapeutically.

It will be understood that each of the elements described above, or two or more together, may also find a useful application in other types of constructions differing from the type described above. While the invention has been illustrated and described as embodiments of an exercise device, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the genetic or specific aspects of this invention.

What is claimed is:

1. An exercise device for a person, comprising:
at least two substantially rigid rails, each rail having an outer surface, and inner surface, and at least one peripheral edge connecting the outer surface to the inner surface, the at least one peripheral edge including at least one axle slot formed therein;
at least one substantially cylindrical axle having two ends and adapted for rotatably and removably receiving at least one substantially cylindrical roller thereon, each end of each axle adapted to be captured within one of the axle slots of one of the rails, each roller having a peripheral surface and a maximum diameter, each axle spaced a distance from an adjacent axle of at least the maximum diameter of the rollers,
whereby each roller may rotate freely on the at least one axle, the exercise device able to support the person lying on his back on the rollers on a flat surface.

2. The exercise device of claim 1 wherein each rail further includes a locking clip pivotally fixed thereto proximate each axle slot, each locking clip adapted for selective detented placement in an open or closed position.

3. The exercise device of claim 1 wherein the peripheral surface of at least one roller includes a plurality of raised portions that form a tread pattern thereon.

4. The exercise device of claim 3 wherein the plurality of raised portions are each less than 0.25 inches in height.

5. The exercise device of claim 3 wherein the plurality of raised portions are each substantially between 0.25 inches and 0.75 inches in height.

6. The exercise device of claim 3 wherein the plurality of raised portions are each substantially greater 0.75 inches in height.

7. The exercise device of claim 3 wherein the plurality of raised portions are each made from a resilient foam material.

8. The exercise device of claim 3 wherein the plurality of raised portions are each made from a rigid plastic material.

9. A method of exercising and massaging a back of a person, comprising the steps of:
a) providing an exercise device as recited in claim 1;
b) instructing the person to position the exercise device between his back and a flat surface; and
c) instructing the person to use his legs to move his back, back and forth to allow the rollers to roll between his back and the flat surface, thereby exercising and massaging the back of a person.
